(19) United States
(12) Patent Application Publication
(10) Pub. No.: US 2002/0118548 A1
(43) Pub. Date: Aug. 29, 2002

(54) Vehicle lamp

(75) Inventors: Rolf Kuenstler, Eisenach (DE); Daniel Matthie, Gerstungen (DE)

Correspondence Address: SUGHRUE MION, PLLC, 2100 Pennsylvania Avenue, N.W., Washington, DC, 20037-3213, US

(73) Assignee: FER FAHRZEUGELKTRIK GMBH

(21) Appl. No.: 10/074,691

(22) Filed: Feb. 14, 2002

(30) Foreign Application Priority Data
Feb. 14, 2001 (DE) 201 02 587.6

(51) Int. Cl. F21V 7/00; B60Q 1/26

(52) U.S. Cl. 362/518; 362/541; 362/544; 362/545; 340/468

(57) ABSTRACT

A vehicle lamp, in particular a high-set brake lamp for motor vehicles, includes a plurality of light sources which are arranged in mutually juxtaposed relationship in a row which is substantially horizontal in the position of installation. Associated with each light source is a part-parabolic reflector and the light source is arranged in laterally displaced relationship with respect to its associated reflector in such a way that the light directly emitted thereby is radiated inclined from below into the reflector and is emitted therefrom outwardly through a light exit cover. In order to comply with modern design demands and to make it possible to impose on the light issuing from the lamp a selectable distribution the light exit cover is in the form of an optically inactive component and the reflective surface of each reflector has an optically operative structure which deflects the reflected light with a desired distribution into predeterminable angular regions.

The invention concerns a vehicle lamp, in particular a high-set brake lamp for motor vehicles of the kind set forth in claim 1.

Such lamps are known for example from DE-OS No 196 47 094. A disadvantage with those known arrangements is that the light exit cover must have an optically operative structure in order to achieve the required or desired distribution of the light which issues from the lamp. This does not comply with the modern demands which aim at a design which is as clear as possible and which allows the technical structures of such a lamp to show.

Accordingly, the object of the invention is to provide a vehicle lamp of the kind set forth in the opening part of this specification, which complies with modern design demands and which nonetheless makes it possible to impose on the light issuing from the lamp a selectable distribution which complies with the statutory requirements.

To attain that object the invention provides the features set forth in claim 1.

By virtue of the fact that the light exit cover is in the form of an optically inactive component which does not in any way influence the distribution of the light which issues from the lamp, the lamp according to the invention enjoys an appearance which complies with modern design demands as it is possible to view from the outside into the lamp, in particular in the opposite direction to the direction of light emission, and it is possible to discern the mirror-like reflector arrangement disposed therein. The reflecting surfaces of the individual reflectors of that arrangement admittedly substantially follow a part-parabolic envelope surface, but they are divided into a plurality of surface portions or facets which are tilted with respect to that envelope surface and whose number, size and tilt or inclination in space can be varied within wide limits in order to achieve the respectively desired or required distribution of light.

Further advantageous embodiments of a vehicle lamp according to the invention are set forth in the appendant claims.

The invention is described hereinafter by means of an embodiment with reference to the drawing in which:

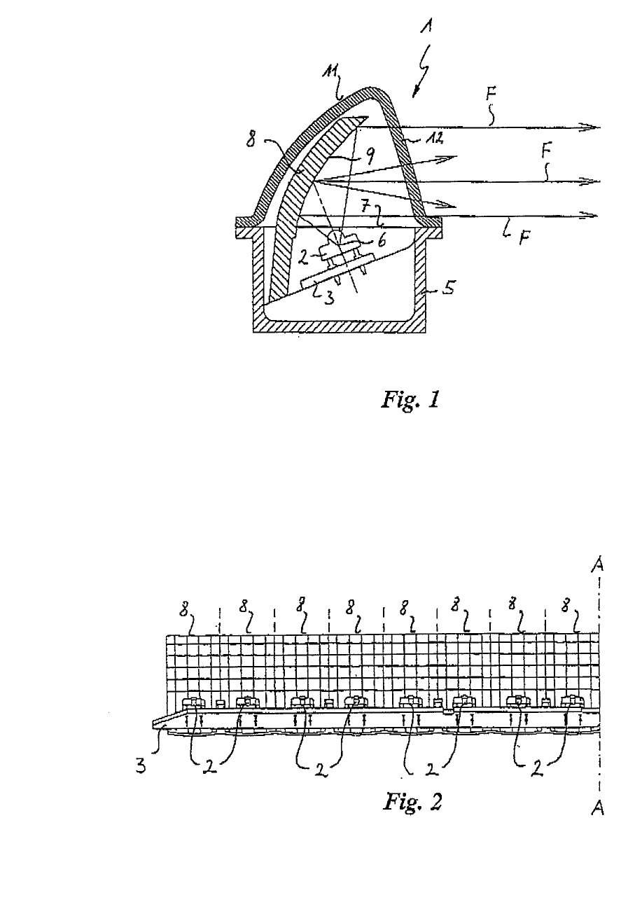

FIG. 1 is a diagrammatic view in section through a vehicle lamp according to the invention, and

FIG. 2 is a view looking in the opposite direction to the direction of light emission, of the light emitting diode and reflector arrangement of the vehicle lamp shown in FIG. 1, which is halved at the line A-A.

As can be seen from FIG. 1, the light emitting diodes 2 of a high-set brake lamp 1 according to the invention are mounted on a common printed circuit board 3 which, in the position of installation shown in FIG. 1, being inclined with respect to the horizontal upwardly and rearwardly, that is to say in opposite relationship to the light-emission direction represented by the arrow F, is installed in a trough-like housing 5 of substantially rectangular cross-section and of non-translucent material, in such a way that the light-emitting region 6 of the light emitting diodes 2 is disposed just below the top edge 7 of the housing 5.

A part-parabolic reflector 8 is mounted in the housing 5 in such a way that, with its reflective surface 9, it projects upwardly out of the housing. By virtue of that arrangement, the light which is shone by the respective light emitting diode 2 into the reflector 8 inclinedly from below is emitted substantially in a horizontal direction (arrow F). Thus, the light emitting diodes 2 are not directly visible when viewing from the rear, that is to say in the opposite direction to the direction of the arrows F, on to the brake lamp 1 according to the invention.

Fitted on to the housing 5 is a cap 11 of translucent material which is approximately triangular in the cross-section shown in FIG. 1 and whose part which is at the right in FIG. 1 forms the light exit cover 12 of the brake lamp 1 according to the invention.

It is essential in that respect that the light exit cover 12 is in the form of an optically inactive component and has no influence whatever on distribution of the light issuing from the brake lamp 1.

In accordance with the invention that function is performed by the reflectors 8 of which, as shown in FIG. 2 which illustrates only half the arrangement, there are sixteen arranged in mutually juxtaposed relationship and integrally connected together. As can be seen from FIG. 2 the reflective surface of each reflector 8 is subdivided into a plurality of facets which are individually tilted with respect to the envelope surface forming the part-parabola in order to achieve a desired distribution of light.

1. A vehicle lamp, in particular a high-set brake lamp (1) for motor vehicles, which includes a plurality of light sources (2) which are arranged in mutually juxtaposed relationship in a row which is substantially horizontal in the position of installation, wherein associated with each light source (2) is a part-parabolic reflector (8) and the light source (2) is arranged in laterally displaced relationship with respect to its associated reflector (8) in such a way that the light directly emitted thereby is radiated inclinedly from below into the reflector (8) and is emitted therefrom outwardly through a light exit cover (12), characterised in that the light exit cover (12) is in the form of an optically inactive component and that the reflective surface (9) of each reflector (8) has an optically operative structure which deflects the reflected light with a desired distribution into predeterminable angular regions.

2. A vehicle lamp as set forth in claim 1 characterised in that the light sources (2) are formed by light emitting diodes.

3. A vehicle lamp as set forth in claim 1 or claim 2 characterised in that the optically operative structure of each reflector (8) is formed by facets.

4. A vehicle lamp as set forth in one of the preceding claims characterised in that the reflectors (8) are integrally connected together and that a common light exit cover (12) is associated with all reflectors (8).

5. A vehicle lamp as set forth in one of the preceding claims characterised in that the light sources (2) are mounted on a common printed circuit board (3) which in the position of installation is inclined relative to the horizontal.

6. A vehicle lamp as set forth in one of the preceding claims characterised in that the light sources (2) are arranged in a trough-like housing (5) of non-translucent material, which is open towards one side, in such a way that its light-emitting region (6) is just within the edge (7) of the opening of the housing, wherein the respectively associated reflector (8) projects out of the housing, and that the light exit cover (12) is part of a cap (11) of translucent material which is fitted on to the housing (5) and which closes the opening of the housing.
